(19) United States
(12) Patent Application Publication
(10) Pub. No.: US 2010/0042469 A1
(43) Pub. Date: Feb. 18, 2010

(54) MOBILE DEVICE ENHANCED SHOPPING EXPERIENCE

(75) Inventors: Raman Chandrasekar, Seattle, WA (US); Tian Bai, Beijing (CN); Eric I. Chang, Beijing (CN); Michael Tsang, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/193,677

(22) Filed: Aug. 18, 2008

(51) Int. Cl. G06Q 30/00; G01C 21/00

(52) U.S. Cl. 705/10; 705/26; 705/27; 701/300; 705/14.1; 705/14.65; 705/14.64; 705/14.66

(57) ABSTRACT

A software and/or hardware facility for providing a mobile device enhanced shopping experience is disclosed. The facility may determine a user characteristic of a mobile device user and deliver information in response to a product query. The information may include product information, competitive pricing information, competitive product information, related product information, a product advertisement, and/or the like. Also, the product query may be based on barcode information, a barcode image, product information, a product image, and/or the like.

### BACKGROUND

The popularity of online shopping has dramatically increased in recent years. In part, this popularity is due to extended shopping hours, the vast selection of merchandise, and the ready availability of peer reviews, product comparisons, and price comparisons associated with online shopping. However, online shopping purchases are typically shipped to purchasers. Accordingly, users may prefer traditional shopping (e.g., brick and mortar stores) when they desire instant gratification, have an urgent need for the product, wish to test, try out, or otherwise interact with the product, and/or the like.

Mobile communications services such as wireless telephony, wireless data services, and wireless email are being used increasingly for both business and personal purposes. Mobile communications services now provide real-time or near real-time delivery of electronic communications and network access over large geographical areas. Likewise, users may employ mobile communications services to access online resources and to communicate with others from any number of locations and/or in any number of situations.

### SUMMARY

A software and/or hardware facility for providing a mobile device enhanced shopping experience is disclosed. The facility may determine a user characteristic of a mobile device user and deliver information in response to a product query. The information may include product information, competitive pricing information, competitive product information, related product information, a product advertisement, and/or the like. Also, the product query may be based on barcode information, a barcode image, product information, a product image, and/or the like.

This Summary is provided to introduce a selection of concepts in a simplified form that are further described in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a suitable environment for practicing aspects of the invention.

FIG. 2 illustrates a system for enhancing a shopping experience.

FIG. 3 illustrates a facility for enhancing a shopping experience.

FIG. 4 is a logical flow diagram of a process for enhancing a shopping experience.

### DETAILED DESCRIPTION

A software and/or hardware facility for providing a mobile device enhanced shopping experience is disclosed. The facility may determine a user characteristic of a mobile device user and deliver information in response to a product query. The information may include product information, competitive pricing information, competitive product information, related product information, a product advertisement, and/or the like. Also, the product query may be based on barcode information, a barcode image, product information, a product image, and/or the like.

The facility may be employed to further integrate mobile devices into users' daily lives, including their shopping experiences. For example, users may employ the facility to receive product and competitive product information while shopping at retail stores. When used in this manner, the facility may provide users with the benefits of online shopping during traditional shopping experiences. Examples of suitable information that may be provided can include information regarding a queried product and recommendations for merchants, similar products and/or related products. Likewise, the facility may also provide pricing information, local availability data, product reviews, and/or the like, for these and other products. The information may be provided in, or include, an advertisement and may be presented to users as they are preparing to make a retail purchase. In addition, the facility may provide a mechanism for users to purchase these and other products via their mobile devices.

The facility may also employ obtained information to track a user's behavior. For example, the facility may track the user's shopping habits, exercise habits, dietary habits, activities, and/or the like. The obtained information may be employed to refine the delivery of information to the user, provide behavioral guidance and/or feedback for the user's consideration, and/or the like. The behavioral guidance and/or feedback may also include data from subject matter experts and/or Internet resources.

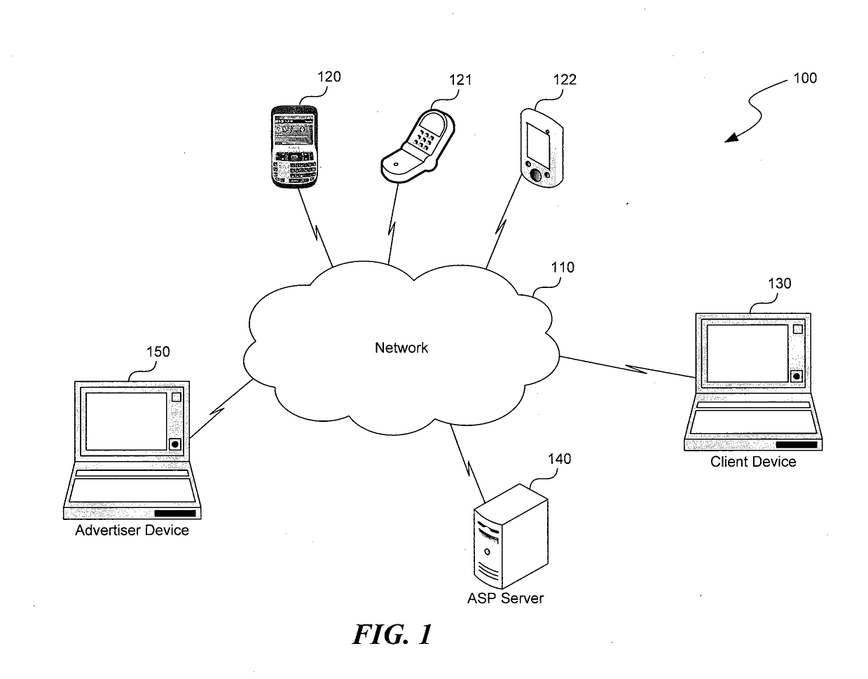

FIG. 1 illustrates a suitable environment in which aspects of the invention may be practiced. However, various modifications, such as the inclusion of additional devices, consolidation and/or deletion of various devices, and the shifting of functionality from one device to another, may be made without deviating from the invention. Environment 100 includes network 110, mobile devices 120-122, client device 130, advertisement service provider (ASP) server 140, and advertiser device 150.

Network 110 is configured to interconnect various computing devices such as mobile devices 120-122, client device 130, ASP server 140, and advertiser device 150 to each other and to other resources. In addition, network 110 may include any number of wired and/or wireless networks, including the Internet, intranets, local area networks (LANs), metropolitan area networks (MANs), wide area networks (WANs), personal area networks (PANs), direct connections, and/or the like. Additional computing devices such as routers, network switches, hubs, modems, firewalls, gateways, Radio Network Controllers (RNCs), proxy servers, access points, base stations, and/or the like may be employed to facilitate communications.

Further, the various computing devices may be interconnected with T1 connections, T3 connections, OC3 connections, frame relay connections, Asynchronous Transfer Mode (ATM) connections, microwave connections, Ethernet connections, token-ring connections, Digital Subscriber Line (DSL) connections, and/or the like. In addition, network 110 may also utilize any wireless standard and/or protocol. These include, for example, Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Universal Mobile Telecommunications System (UMTS), Advanced Mobile Phone System (AMPS), Worldwide Interoperability for Microwave Access (WiMAX), Wireless Fidelity (WiFi), and/or the like.

Mobile devices 120-122 may include virtually any portable computing devices capable of receiving and sending messages over a network, such as network 110. Such devices include portable devices such as cellular telephones, display pagers, radio frequency (RF) devices, infrared (IR) devices, Personal Digital Assistants (PDAs), handheld computers, laptop computers, wearable computers, tablet computers, integrated devices combining two or more of the preceding devices, and/or the like. As such, mobile devices 120-122 range widely in terms of capabilities and features. For example, a cellular telephone may have a numeric keypad and the capability to display only a few lines of text. However, other cellular telephones (e.g., smart phones) may have a touch-sensitive screen, a stylus, and a relatively high-resolution display.

Mobile devices 120-122 may typically include a processing unit, volatile memory and/or nonvolatile memory, a power supply, one or more network interfaces, an audio interface, a display, a keypad or keyboard, a Global Positioning System (GPS) receiver and/or other location determination device, and other input and/or output interfaces. Also, the various components of mobile devices 120-122 may be interconnected via a bus.

The volatile and nonvolatile memories generally include computer storage media for storing information such as computer readable instructions, data structures, program modules, or other data. Some examples of information that may be stored include basic input/output systems (BIOS), operating systems, and applications. In addition, the memories may be employed to store operational data, content, contexts, and/or the like.

The memories may also store one or more client applications that are configured to receive, forward, and/or provide content, such as advertisements and other messages, from and/or to another computing device. Content may also be displayed and/or stored on mobile devices 120-122. The content may include advertisements contained within short message service (SMS) messages, multimedia message service (MMS) messages, instant messaging (IM) messages, enhanced message service (EMS) messages, and/or any advertisements or other content directed toward a user of mobile devices 120-122, such as audio data, multimedia data, photographs, video data, still images, text, graphics, animation files, voice messages, and text messages. The memories may also store one or more client applications that are configured to provide a product query and/or advertisement targeting information to other computing devices and/or to enable a user to respond to an advertisement (e.g., redeem a coupon, interact with an advertisement, reject an advertisement, etc.).

Mobile devices 120-122 may also provide identifiers to other computing devices. These identifiers may include identification of a type, capability, and/or name of each particular mobile device. In one embodiment, mobile devices 120-122 may uniquely identify themselves and/or identify a group association through any of a variety of mechanisms, including a phone number, a Mobile Identification Number (MIN), an electronic serial number (ESN), a Media Access Control (MAC) address, a personal identification number (PIN), an RF signature, and/or other identifier.

Client device 130 may include virtually any computing device capable of communicating over a network. Typically, client device 130 is a computing device such as a personal computer (PC), multiprocessor system, microprocessor-based or programmable consumer electronic device, and/or the like. In addition, client device 130 may be a television, digital video recorder, media center device, set-top box, other interactive television device, and/or the like. Also, client device 130 may store and/or execute client applications with the same or similar functionality as those stored on the memories of mobile devices 120-122. For example, client device 130 may store one or more client applications that are configured to provide a product query and/or advertisement targeting information to other computing devices and/or to enable a user to respond to an advertisement. In certain instances, content may be delivered to a mobile device user at client device 130 instead of on a mobile device.

ASP server 140 may include any computing device capable of connecting to network 110 to provide content to users of mobile devices 120-122 and/or client device 130. ASP server 140 may also be configured to manage online advertising and provide product and other information. Devices that may operate as ASP server 140 include personal computers, desktop computers, multiprocessor systems, microprocessor-based or programmable consumer electronic devices, servers, and/or the like. Likewise, ASP server 140 may include a single computing device; the functionality of ASP server 140 may be distributed across multiple computing devices; or ASP server 140 may be integrated into another device such as an SMS gateway, an advertisement server, and/or the like.

Advertiser device 150 may include virtually any computing device capable of communicating over a network. Typically, advertiser device 150 is a computing device such as a personal computer, multiprocessor system, microprocessor-based or programmable consumer electronic device, and/or the like. Also, advertiser device 150 may be utilized by an advertiser to provide advertisements and/or other information to ASP server 140 and/or mobile devices 120-122 and/or to interact with a user following advertisement responses (e.g., to complete a sale, to register a user, to provide information, etc.). Also, advertiser device 150 may be configured to operate as a merchant platform (e.g., an online merchant web server, point-of-sale cash register or terminal, network-enabled vending machine, inventory management system, telephone sales system, etc.). In addition, advertiser device 150 may also be employed to provide information corresponding to advertisements, such as targeting information, advertising budget, advertising campaign characteristics, advertiser information, and/or the like to ASP server 140.

Additional details regarding mobile devices 120-122, client device 130, ASP server 140, advertiser device 150, and the functionalities thereof are discussed below.

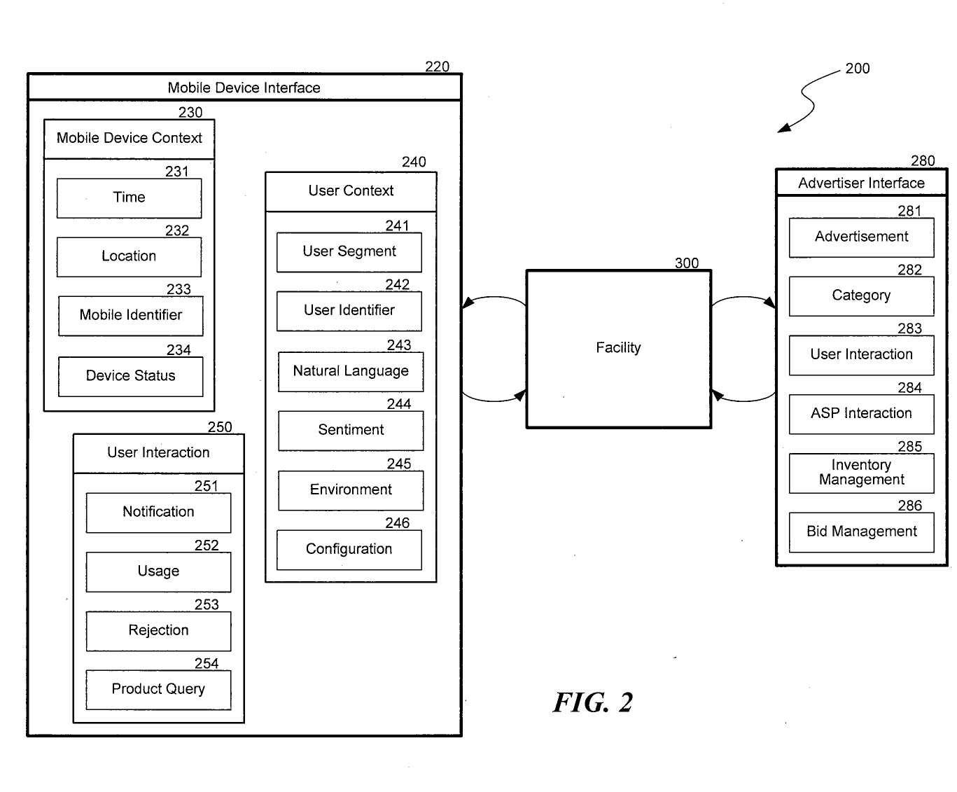

FIG. 2 illustrates content delivery system 200. As illustrated, system 200 includes facility 300, configured to receive inputs from mobile device interface 220 and advertiser interface 280. For clarity, system 200 and the functionalities thereof are described below as being performed by particular elements of environment 100 of FIG. 1. However, system 200 and the functionalities thereof may also be, for example, performed by or on other processors, elements, or devices whether or not such processors, elements, or devices are described herein.

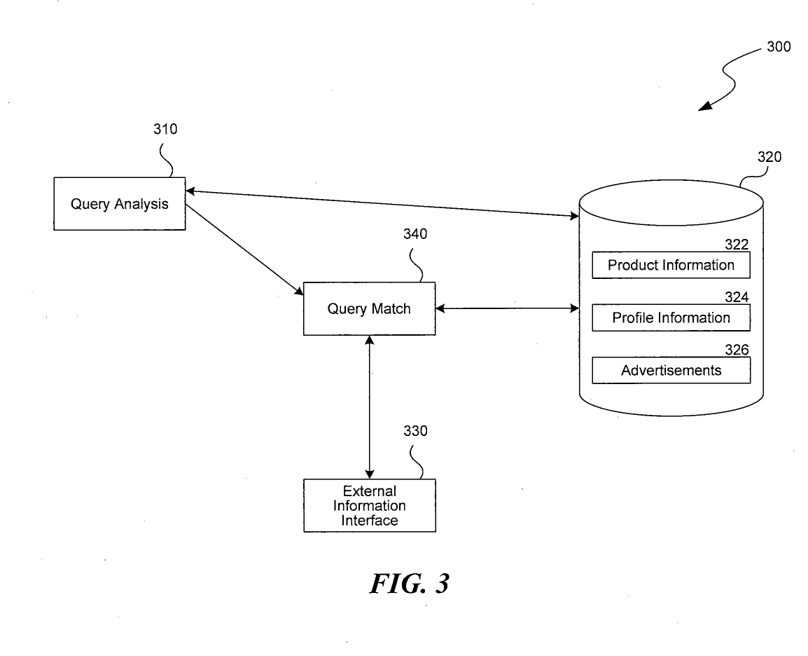

Facility 300 may include a software and/or hardware facility used to enhance a user's shopping experience. For example, facility 300 may provide content, such as the content discussed above, to a mobile device user via one or more shopping information messages. In one example, facility 300 may also provide an advertisement to the mobile device user and enable the user to purchase an advertised product via one or more shopping information messages. Facility 300 is described in further detail in conjunction with FIG. 3.

Mobile device interface 220 may be provided to enable facility 300 to receive input from, and to communicate with, a mobile device. As illustrated, mobile device interface 220 includes mobile device context component 230, user context component 240, and user interaction component 250. In one example, mobile device interface 220 may be implemented on mobile devices 120-122 or client device 130. However, mobile device interface 220 may also be implemented on ASP server 140, advertiser device 150, and/or any other suitable device.

Mobile device interface 220 may employ either “push” or “pull” technologies to communicate with facility 300. For example, mobile device interface 220 may push context information to facility 300 on a continuous, periodic, or nonperiodic basis. Likewise, facility 300 may push content to mobile device interface 220 based on received context information, and/or mobile device interface 220 may request, with or without context information, content, such as an advertisement from facility 300. In one example, a user may request a certain category of advertisement (e.g., a dining coupon) from facility 300 via mobile device interface 220. In another example, facility 300 is configured to push product information to mobile device interface 220 in response to a product query.

Mobile device context component 230 may be configured to provide any characteristics of a mobile device that would be useful for targeting content. As shown, mobile device context component 230 includes time module 231, location module 232, mobile identifier module 233, and device status module 234. However, mobile device context component 230 may include other modules.

Time module 231 may be employed to determine the current time and/or to measure durations of time. Time module 231 may include a clock, a timer, or a component to determine time from a broadcast time signal, a GPS signal, or any other time source. For example, time information may be employed by itself or in conjunction with other information to determine whether message delivery is currently appropriate (e.g., during daytime hours, while the user is not in a business meeting, etc.).

Location module 232 may be employed, for example, to determine the location of mobile device 120. The location of mobile device 120 may be determined by GPS, triangulation from broadcast tower signals and/or WiFi access point signals, manual entry by a user, schedule information, or any other location determination technique. This location information may be employed to provide geographically relevant content, such as advertisements, information, coupons, notifications, and/or offers. In addition, location information may further include speed and/or directional information relating to the mobile device. For example, speed and/or directional information may be employed to determine whether message delivery is currently appropriate and/or to provide geographically relevant content at a predicted destination and/or along a predicted route.

Mobile identifier module 233 may be employed to provide any useful mobile identifier to facility 300. For example, mobile identifiers may include device identifiers discussed above with respect to FIG. 1.

Device status module 234 may also be employed to provide device status information to facility 300. In one example, device status information includes a status of mobile device 120, such as whether mobile device 120 is currently employed for processing a voice telephone call, Internet browsing, processing email, playing music or video, and/or the like. Likewise, device status information may also include whether the mobile device is in a wireless communications service area, what the signal strength of a wireless communications signal is, whether peripheral devices (e.g., data storage devices, input/output devices, etc.) are connected, and/or the like.

User context component 240 may be configured to provide real-time, near real-time, and/or non-real-time user context characteristics to facility 300 that may be useful for targeting content and/or selectively providing content that are relevant to, for example, a user's mood, environment, or tasks. As shown, user context component 240 includes user segment module 241, user identifier module 242, natural language module 243, sentiment module 244, environment module 245, and configuration module 246.

User segment module 241 may be provided to identify characteristics of a user and/or group of users. For example, user segment module 241 may be employed to identify a group of users that share any one or more characteristics. Such characteristics may include geographic characteristics (e.g., location, population density (urban, semi-urban, rural), climate, etc.); demographic characteristics (e.g., age, gender, family size, education, income, occupation, socioeconomic status, religion, ethnicity, language, etc.); and/or behavioral characteristics (e.g., product usage rate, brand loyalty, readiness to buy, income status, etc.).

Any population of individuals may be divided into two or more segments by facility 300, such that the characteristics of each group association may provide information that is useful to target content to users in that particular segment. These characteristics may also be determined by analyzing information received from a user, received from a third party, and/or inferred through a user's use of a mobile device. Although illustrated as within mobile device interface 220, user segment module 241 may also be integrated within facility 300.

User identifier module 242 may provide any useful user identifier to facility 300. For example, user identifiers may include usernames or other identifiers corresponding to the user of a mobile device. Facility 300 may also employ a user identifier if a mobile device user uses multiple mobile devices or if multiple users share a single mobile device.

Natural language module 243 and sentiment module 244 are respectively configured to provide natural language and sentiment information to facility 300. As one example, natural language and sentiment information may be based on a user's interaction with or through, for example, mobile device 120, may include textual, speech, and physiological information, and may be extracted from text messages, mobile browser queries, voice messages, telephonic discussions, notes, and/or any other information available to mobile device 120.

In one example, natural language information may be analyzed to determine the subject matter of the mobile device user's interaction with mobile device 120. Likewise, sentiment information may be analyzed to determine the user's emotional state, attitude, needs, or intent. For example, a user's mood, stress level, workload, and/or the like, may be inferred based on analyzing sentiment information. In addition, natural language and/or sentiment information may be analyzed to infer user context and/or user intent.

Natural language and/or sentiment analysis may employ any suitable analysis algorithms, methods, procedures, and/or the like. For example, natural language processing algorithms, voice recognition algorithms, pattern matching algorithms, computational linguistics algorithms, text mining algorithms, semantic analysis algorithms, vector analysis algorithms, and/or the like may be employed to analyze natural language and/or sentiment information. Custom and/or situational-specific vocabularies, libraries, models, and/or the like may also be employed.

Natural language and/or sentiment information may be extracted by mobile device 120 for on-board analysis and/or analysis at client device 130 and/or ASP server 140. However, natural language and/or sentiment information may be extracted at any other suitable computing device, such as ASP server 140, a wireless communications service base station, and/or the like. For example, natural language and/or sentiment information may be extracted by a wireless communications service base station in communication with mobile device 120.

User context module 240 may also include environment module 245, which may be used to ascertain or receive environmental information. For example, environmental information may include ambient temperature, body temperature, heart rate, humidity, pressure, current weather, traffic conditions, motion and/or orientation of mobile device 120, proximity to other mobile devices, and/or the like. Mobile device 120 may include various sensors to produce these and other examples of environmental information. However, certain examples of environmental information may be sensed at or by a server and/or provided by a third party. For example, proximity to other mobile devices may be determined at a communications service provider server, and current weather information may be provided by a third-party weather service.

Configuration module 246 may provide configuration information to facility 300. The configuration information may include a user's configurable preferences, configuration settings, configuration data, and/or schedule information. Some examples of suitable configuration information include the hours during which a user is willing to receive advertisements, the user's dietary preferences, the user's typical and/or anticipated travel plans, the user's calendar information and/or other schedule information, and/or the like. Also, calendar and schedule information may include information regarding the user's business meetings, personal meetings, events, task lists, and/or the like.

Configuration module 246 may also be included in and/or provide content targeting information to facility 300 as further discussed in the concurrently filed U.S. Patent Application entitled “Context Based Online Advertising” by R. Chandrasekar et al., having attorney docket number 418268481 US, the entirety of which is hereby incorporated by reference. Configuration module 246 may also be included in and/or provide content targeting information to facility 300 as further discussed in the concurrently filed U.S. Patent Application entitled “Context Based Advertisement Filtration” by E. Chang et al., having attorney docket number 418268483US, the entirety of which is hereby incorporated by reference.

Additional preference information may be determined by observing text that a user has entered, past searches that the user has performed, bookmarks that have been saved by the user, messages the user may have sent or received, or other indications of subject matter of interest to the user. For example, mobile device 120 may include a record of the user's pattern of usage for certain words, phrases, URLs, etc. In another example, mobile device 120 or ASP server 140 may include a record of purchases made by the user. In yet another example, mobile device 120 may include a record of the user's entertainment media, such as available audio and video media titles that are stored on or accessible via mobile device 120.

User interaction component 250 may also be provided to enable facility 300 to receive input from, and to communicate with, a user. As illustrated, user interaction component 250 includes notification module 251, usage module 252, rejection module 253, and product query module 254. In one example, user interaction component 250 may be implemented on mobile devices 120-122 or client device 130. However, it may also be implemented on ASP server 140, advertiser device 150, and/or any other suitable device.

Notification module 251 may be configured to notify a user of incoming content. For example, notification module 251 may include an email client application, an SMS client application, a really simple syndication (RSS) client application, and/or the like. Notification module 251 may also be selectively configured to notify a user of incoming content based on the user's context as further discussed in the concurrently filed U.S. Patent Application entitled “Context Based Advertisement Filtration” as incorporated by reference above.

Usage module 252 may provide usage data indicative of a user's interaction with content. For example, usage data may include whether the user viewed incoming content such as an advertisement, requested further information, made a purchase, saved a message for later viewing, modified a behavior based on provided guidance, and/or the like.

Rejection module 253 may provide information regarding a user's rejection of delivered content. For example, rejection module 253 may be employed by a user to indicate that content is unwanted or irrelevant, that the user elected to ignore provided guidance, and/or the like. Rejection module 253 may also be configured to infer a user's response to content based on either passive or active actions. For example, rejection module 253 may be configured to infer a rejection of content based on whether the content is deleted without being viewed, is viewed for a short duration, is ignored, and/or the like.

Product query module 254 may provide information to facility 300 regarding a product in which a user may be interested. For example, the user may be interested in purchasing the product, may have viewed the product in a store, or may be otherwise interested in learning about the product, similar products, related products, and/or the like. Product query module 254 may include a camera, a barcode scanner, and/or the like, configured to acquire product identification information. For example, product identification information may include barcode information, a barcode image, or a product image. However, product query module 254 may also be configured to receive product information such as a product name, model number, brand or manufacturer, product family, serial number, and/or the like, via any other data entry methods (e.g., text entry, voice entry, etc.). Likewise, product query module 254 may be further configured to simultaneously receive information regarding multiple products such as an entire meal, an assortment and/or collection of products, and/or the like.

Facility 300 may receive input from, and communicate with, an advertiser via advertiser interface 280. As illustrated, advertiser interface 280 includes advertisement module 281, category module 282, user interaction module 283, ASP interaction module 284, inventory management module 285, and bid management module 286. In one example, advertiser interface 280 may be implemented on advertiser device 150. However, advertiser interface 280 may also be implemented on mobile devices 120-122, client device 130, ASP server 140, and/or any other suitable device.

Advertisement module 281 may be configured to provide advertisements and other corresponding information to facility 300. Advertisements may include virtually any information that an advertiser presents to an audience in any format or through any medium. Nonlimiting examples of suitable advertisements include coupons, textual advertisements, notifications of upcoming events, notifications of promotions, and/or the like. Also, advertisements may be either commercial or noncommercial in nature. For example, advertisements may be included with and/or intended for electronic delivery via email, SMS messages, MMS messages, and/or the like. However, other delivery methods may also be suitably employed. Advertisement module 281 may also be configured to provide corresponding information to facility 300. Corresponding information may include targeting information, budget information, advertising campaign characteristics, and/or the like.

Category module 282 may be provided to categorize received advertisements by any suitable characteristics, such as the value of the offer (e.g., dollar amount of discount, percentage amount of discount, status as free, lack of discount, etc.), the type of merchandise offered (e.g., food, clothes, electronics, events, etc.), the type of content (e.g., video advertisement, text advertisement, coupon, etc.), the timing of the offer, user-defined categories, and/or the like. Although illustrated as within advertiser interface 280, category module 282 may also be integrated within facility 300.

User interaction module 283 may be configured to enable interaction between an advertiser and users who receive advertisements. For example, advertiser interface 280 may be configured to provide additional information regarding a product and/or service, to conduct transactions with users, to track user responses to advertisements, to collect information regarding users, and/or the like. In one example, user interaction module 283 includes an advertiser's point-of-sale device configured to track redemption of coupons provided in advertisements. However, other devices may also suitably function as user interaction module 283.

ASP interaction module 284 may be configured to enable interaction between an advertiser and an ASP. For example, ASP interaction module 284 may enable communication of advertising budget information, advertisement effectiveness information, advertisement response information, and/or the like, between ASP server 140 and advertiser device 150. In one system, ASP interaction module 284 is configured to provide real-time communications between an ASP and an advertiser. However, in other systems, ASP interaction module 284 may provide delayed communications, batched communications, periodic communications, and/or the like. In one example, facility 300 may employ the information received from ASP interaction module 284 to improve and/or refine any bidding mechanisms of system 200.

Inventory management module 285 may be configured to manage and/or provide inventory information. Likewise, inventory management module 285 may also be configured to receive advertising information (e.g., number of advertisements provided to users, historical redemption rates, expected redemption rate, etc.). For example, inventory management module 285 may be employed to adjust bid prices based on inventory levels and/or to adjust inventory based on anticipated demands.

Bid management module 286 may be configured to provide bids to facility 300, for example, to indicate an advertiser's willingness to pay for delivery of an advertisement, redemption of a coupon, and/or the like. For example, bid management module 286 may calculate a bid as a function of the category of the advertisement, the time at which the advertisement is to be delivered, the location of the user when the advertisement is delivered, a specific user segment to which the user belongs, and/or the like.

Bid management module 286 may also be employed to receive information relating to the effectiveness of the advertiser's or other advertisers' advertisements. This information may include either generic information and/or information specific to an advertiser, advertisement category, particular advertisement, and/or the like. Bid management module 286 may also employ such information to determine bid prices, modify advertisements, cancel advertisements, and/or the like.

In operation, information from these and other modules may be employed to provide content to a user, as discussed below.

FIG. 3 illustrates facility 300. As illustrated, facility 300 includes query analysis component 310, database 320, external information interface 330, and query match component 340. For clarity, facility 300 and the functionalities thereof are described below as being performed by particular elements of environment 100 of FIG. 1. However, facility 300 and the functionalities thereof may also be, for example, performed by or on other processors, elements, or devices whether or not such processors, elements, or devices are described herein. As discussed above, facility 300 may include a software and/or hardware facility for enhancing a user's shopping experience.

Facility 300 may be implemented on any device. For example, facility 300 may be implemented on ASP server 140 and configured to receive inputs from mobile devices 120-122, client device 130, and/or advertiser device 150. However, facility 300 may also be implemented on, and/or configured to receive input from, any other suitable device. Likewise, the illustrated input sources are provided merely to illustrate some of the many possible input sources for such a facility. In other systems, other, different, fewer, and/or additional inputs may also be suitably employed.

Query analysis component 310 may be configured to interface, for example, with mobile device interface 220 to receive context and product query information; to extract, generate, and/or determine subject product(s) and any action to be taken regarding the subject product(s); and to provide this information to query match component 340. For example, query analysis component 310 may be configured to analyze an image of a barcode to determine a stock keeping unit (SKU) or universal product code (UPC) and to correlate the SKU or UPC to a product. Likewise, query analysis component 310 may also be configured to provide the same or similar information based on an image of a product, a product name, model number, brand or manufacturer, product family, serial number, and/or the like. In addition, query analysis component 310 may be communicatively coupled to database 320, for example, to correlate received product information to a product identifier.

Database 320 may be included in facility 300 to store and/or organize any data relevant to facility 300. As illustrated, database 320 includes product information module 322, profile information module 324, and advertisements module 326. Also, database 320 may be implemented in any type of database. For example, database 320 may include a SQL database, a Microsoft Access database, an Oracle database, a DB2 database, and/or the like.

Product information module 322 may be employed to store and/or organize product information such as product images, model numbers, SKUs, UPCs, brand or manufacturer information, product family information, serial numbers, product features, product specifications, product pricing, product availability, product reviews, and/or the like. Such information may be respectively employed by query analysis component 310 and/or query match component 340 to correlate product query information with product identifiers and/or to determine similar and/or related product and product information for delivery to a user.

Profile information module 324 may be employed to store and/or organize user profile information. This information may be based, for example, on the user's previous interactions with facility 300 and may include any of the information provided by mobile device interface 220. Such information may be analyzed to continuously, periodically, and/or nonperiodically improve facility 300 by accounting for a user's previous interactions with facility 300. These interactions may be analyzed to define user preferences, identify instances of previous message miscategorization, and improve and/or refine the accuracy of a message processing algorithm, and/or a model of user behavior. For example, information from profile information module 324 may be employed to determine whether certain types of behavioral guidance are likely to be appreciated by the user.

Advertisements module 326 may be employed to store and/or organize advertisement information such as advertisements, advertiser information, advertisement targeting information, other information received from advertiser interface 280, and/or the like. Advertisements module 326 may also be employed to store and/or organize advertisement effectiveness information which may be based on a redemption rate, response rate, discount amount, community-based feedback, advertiser popularity, product popularity, service popularity, and/or the like of a selectively delivered advertisement.

Advertisement effectiveness information may also include any of the information further discussed in the concurrently filed U.S. Patent Application entitled “Context Based Advertisement Bidding Mechanism” by T. Bai et al., having attorney docket number 418268480US, the entirety of which is hereby incorporated by reference. Advertisements stored by advertisements module 326 may be received from advertiser interface 280 and may be provided to query match component 340 for possible delivery to a user.

External information interface 330 may be employed to obtain additional product information from external sources to be provided to query match component 340 for possible delivery or inclusion with content to be delivered to a user. For example, external information may include information from subject matter experts, Internet resources, and/or the like, and may regard products, a user's previous behavior, and/or the like.

Query match component 340 may be configured to determine what kind of content may be appropriate for delivery to a user. For example, query match component 340 may make such determinations based on product query information, a user interaction context, a user context, a mobile device context, available content, advertisement targeting information, advertisement effectiveness information, and/or the like. Query match component 340 may optionally determine an appropriate expiration time and/or discount amount for advertisements.

In one example, query match component 340 may operate as a matchmaking system matching advertisements to users likely to respond positively to the advertisements. In addition, information from these and other modules may be employed for gauging, estimating, and/or predicting the demand for products/services (e.g., based on the number of advertisements delivered; based on actual, predicted, and/or historical effectiveness of advertisements; based on the timing of advertisement delivery; etc.). However, query match component 340 may also be employed to selectively deliver other content such as behavioral guidance and/or feedback to a user.

For example, query match component 340 may provide information regarding a queried product, or a user's progress toward a user's behavioral goals (e.g., diet goals, exercise goals, shopping goals, etc.), correlated information from subject matter experts and Internet resources, advice, suggestions for product purchases, and/or the like. Similarity of products may be determined by query match component 340 based on similarity of features, specifications, price, and/or the like.

In operation, facility 300 may operate as a real-time, back-end, and/or adaptive facility to enable users to receive advertisements and other information about products and to purchase products from a mobile device. As facility 300 enables interaction with mobile devices, for example, based on a product query, it may also enable advertisers to interact with a user at a point in time when the user is likely to buy a queried, similar, and/or related product.

Facility 300 may also be employed to increase advertisement service providers (ASPs) and/or advertiser revenue by enabling ASPs to target advertisements or other content to likely interested parties while decreasing the number of advertisements or other content provided to likely uninterested parties. This may enable ASPs to provide, for example, relevant advertisements to users predisposed to certain product advertisements. These users may be more likely to open the advertisement, read the advertisement, interact with the advertisement, make a purchase based on the advertisement, and/or the like. Accordingly, advertisements targeted in this manner may be more effective, and advertisers may be willing to pay increased advertising fees for them.

In one example, facility 300 may be employed in a comparative shopping system that is configured to infer a user's preparation for a product purchase. In this example, facility 300 may provide advertisements for the same, similar, and/or related products. The advertisements may also include a mechanism for purchasing these products via a mobile device, coupons, geographically relevant availability and pricing information, and/or the like. Such advertisements may also include recommendations for specific merchants and/or products.

In this example, facility 300 provides advertisers with a mechanism to provide a marketing and/or cross-selling opportunity to users who are near a point of purchase. In addition, facility 300 may also provide advertisers with a mechanism for advertising products that are similar or very close to specific product or type of product that the customer is almost ready to purchase. Similarity may be based on product prices, features, specifications, information from subject matter experts, and/or the like. For example, users may be more open or receptive to advertisements for these products.

In another example, a user may provide an image of a meal to facility 300 as a product query. Facility 300 may then analyze the image, identify the food within the meal, calculate dietary information, correlate calculated dietary information with user goals and information from subject matter experts or Internet resources, and/or the like. Determined information may be stored for later review, employed to monitor the progress of a diet, used to provide behavioral guidance and/or feedback, and/or the like.

The above examples are provided to illustrate the operation of facility 300. However, these examples merely illustrate some of the many possible inputs for facility 300 and some of the many ways in which facility 300 may utilize its various inputs.

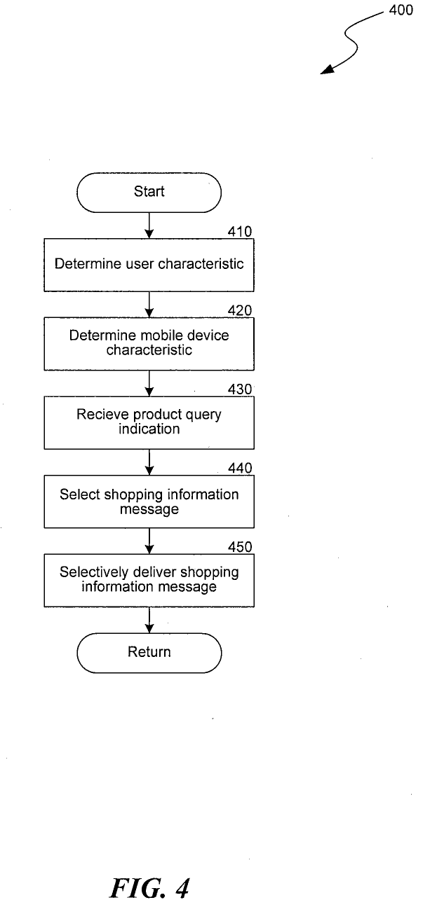

FIG. 4 illustrates process 400 for enhancing a shopping experience. Process 400 may be implemented in software, in hardware, or in a combination of hardware and software. As such, the operations illustrated as blocks in FIG. 4 may represent computer-executable instructions which, when executed, direct a system to enhance a shopping experience. For clarity, process 400 is described below as being performed by particular elements of environment 100 of FIG. 1 and system 200 of FIG. 2. However, process 400 may also be performed by other processors, by other elements, or in other systems, whether or not such processors, elements, or systems are described herein. Likewise, process 400 may be a real-time, near real-time, or non-real-time process.

From a start block, processing begins at block 410 where facility 300 determines a user characteristic. The determined user characteristic may be based on a user interaction context that includes information based on user interactions with one or more previously delivered shopping information messages. For example, the shopping information message may include advertisements, product information, competitive pricing information, competitive product information, related product information or a product advertisement, behavioral guidance and/or feedback messages, and/or any of the other content or information discussed above.

In one example, the user characteristic may also be based on natural language information and/or sentiment information that is extracted from, or otherwise based on, user speech data. However, the user characteristic may also be based on any other characteristic from user context component 240, user interaction component 250, and/or from any other suitable source. For example, the user characteristic may also be based on a user's demographic group or identity, specific user characteristics, specific mobile device, and/or the like. From block 410, processing flows to a block 420.

At block 420, facility 300 determines a mobile device characteristic, for example, based on mobile device context provided by mobile device context component 230. In one example, the mobile device characteristic is a spatio-temporal characteristic such as a time, location, and/or speed of the mobile device. However, the mobile device characteristic may include characteristics from mobile identifier module 233, device status module 234, and/or from any other suitable source. From block 420, processing flows to a block 430.

At block 430, facility 300 receives a product query indication. This indication may be based on barcode information, a barcode image, a product image, or product information, such as a product name, model number, brand or manufacturer, product family, serial number, and/or the like, from product query module 254. In one example, a mobile device may provide a product query indication to pull a shopping information message from facility 300. However, in another system, facility 300 may push shopping information messages to mobile devices based on received product query indications and/or other user interaction information from which a user's shopping activities may be inferred. From block 430, processing flows to block 440.

At block 440, facility 300 selects an advertisement. For example, the advertisement may be selected based on correspondence between the targeting information for the selected advertisement and the mobile device and user characteristics. As discussed below, facility 300 may also select an advertisement based on advertisement effectiveness, previous interaction with the user, and/or the like. However, for some shopping information messages, facility 300 may omit advertisements. From block 440, processing flows to block 450.

At block 450, facility 300 selectively delivers a shopping information message. This selective delivery may be based on mobile device characteristics, user characteristics, the received product query indication, and/or the like. As discussed above, the shopping information message may include advertisements, product information, competitive pricing information, competitive product information, related product information, or a product advertisement, behavioral guidance and/or feedback messages, and/or any of the other content or information discussed above. From block 450, processing returns to other actions. In other examples, from block 450, processing may instead flow to block 410, 420, 430, or 440 to iteratively and selectively deliver any number of additional shopping information messages.

Those skilled in the art will appreciate that the blocks shown in FIG. 4 may be altered in a variety of ways. For example, the order of blocks may be rearranged, substeps may be performed in parallel, shown blocks may be omitted, or other blocks may be included, etc.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel or may be performed at different times. Further, any specific numbers noted herein are only examples, and alternative implementations may employ differing values or ranges. Those skilled in the art will also appreciate that the actual implementation of a database may take a variety of forms, and the term “database” is used herein in the generic sense to refer to any data structure that allows data to be stored and accessed.

We claim:

1. A method for enhancing a shopping experience, comprising:
determining a user characteristic based on a user interaction context including information on a user interaction with a first shopping information message that was previously delivered to a mobile device;
receiving an indication of a product query; and
selectively delivering a second shopping information message to the mobile device based on the determined user characteristic and the received indication.

2. The method of claim 1, wherein the second shopping information message includes at least one of product information, competitive pricing information, competitive product information, related product information, or a product advertisement.

3. The method of claim 1, wherein the second shopping information message includes a coupon.

4. The method of claim 1, wherein the indication includes at least one of barcode information, a barcode image, product information, or a product image.

5. The method of claim 1, wherein the user characteristic is further based on a user context including at least one of natural language information based on a user interaction with the mobile device or sentiment information based on the user interaction with the mobile device.

6. The method of claim 5, wherein determining the user characteristic includes:
extracting the natural language information from the user interaction with the mobile device; and
extracting the sentiment information from the user interaction with the mobile device.

7. The method of claim 5, wherein determining the user characteristic includes:
receiving user speech data; and
extracting at least one of the natural language information or the sentiment information from the received user speech data.

8. The method of claim 1, further comprising:
determining a mobile device characteristic based on a mobile device context of a mobile device, wherein selectively delivering the second shopping information message is further based on the mobile device context.

9. The method of claim 8, wherein the mobile device context includes a location of the mobile device.

10. The method of claim 1, wherein selectively delivering the second shopping information message includes:
selecting an advertisement from multiple advertisements based on the determined user characteristic, the received indication, and an advertisement effectiveness characteristic that includes at least one of a redemption rate, response rate, discount amount, community-based feedback, advertiser popularity, product popularity, or service popularity of a selectively delivered advertisement.

11. A processor-readable medium containing instructions for executing a method of enhancing a shopping experience, wherein the method comprises:
determining a user characteristic based on a user interaction context including information on a user interaction with a first shopping information message that was previously delivered to a mobile device;
determining a mobile device characteristic based on a mobile device context of a mobile device;
receiving an indication of a product query including a barcode image;
selecting an advertisement from multiple advertisements based on the determined user characteristic, the mobile device context, the received indication, and an advertisement effectiveness characteristic that includes a redemption rate, response rate, and discount amount of a selectively delivered advertisement; and
selectively delivering the selected advertisement in a second shopping information message to the mobile device based on the determined user characteristic, the mobile device context, and the received indication.

12. The processor-readable medium of claim 11, wherein the second shopping information message includes at least one of product information, competitive pricing information, competitive product information, related product information, or a product advertisement, and wherein the indication further includes at least one of product information or a product image.

13. The processor-readable medium of claim 11, wherein the user characteristic is further based on a user context including at least one of natural language information based on a user interaction with the mobile device and sentiment information based on the user interaction with the mobile device.

14. The processor-readable medium of claim 11, wherein the mobile device context includes a location of the mobile device.

15. The method of claim 11, wherein determining the user characteristic includes:
receiving user speech data; and
extracting at least one of natural language information or sentiment information from the received user speech data.

16. The processor-readable medium of claim 11, wherein the advertisement effectiveness characteristic further includes at least one of community-based feedback, advertiser popularity, product popularity, or service popularity of the selectively delivered advertisement.

17. A computing system configured to enhance a shopping experience, comprising:
a memory;
a first module configured, when executed in the memory, to determine a user characteristic based on a user interaction context including information on a user interaction with a first shopping information message that was previously delivered to a mobile device;
a second module configured, when executed in the memory, to receive an indication of a product query; and
a third module configured, when executed in the memory, to selectively deliver a second shopping information message to the mobile device based on the determined user characteristic and the received indication.

18. The computing system of claim 17, wherein the second shopping information message includes at least one of product information, competitive pricing information, competitive product information, related product information, or a product advertisement, and wherein the indication includes at least one of barcode information, a barcode image, product information, or a product image.

19. The computing system of claim 17, further comprising:
a fourth module configured, when executed in the memory, to determine a mobile device characteristic based on a mobile device context including a location of a mobile device, wherein selectively delivering the second shopping information message is further based on the mobile device context.

20. The computing system of claim 17, wherein selectively delivering the second shopping information message includes:
selecting an advertisement from multiple advertisements based on the determined user characteristic, the received indication, and an advertisement effectiveness characteristic that includes at least one of a redemption rate, response rate, discount amount, community-based feedback, advertiser popularity, product popularity, or service popularity of a selectively delivered advertisement.
